(19) United States
(12) Patent Application Publication
(10) Pub. No.: US 2023/0252652 A1
(43) Pub. Date: Aug. 10, 2023

(54) HUMAN BODY DETECTION DEVICE AND HUMAN BODY DETECTION METHOD

(71) Applicant: OMRON Corporation, Kyoto-shi, Kyoto (JP)

(72) Inventor: Kiyoaki TANAKA, Kyoto-shi, KYOTO (JP)

(21) Appl. No.: 18/002,400

(22) PCT Filed: Jun. 22, 2021
(86) PCT No.: PCT/JP2021/023622

§ 371 Date: Dec. 19, 2022

(30) Foreign Application Priority Data
Jul. 8, 2020 (JP) 2020-117925

(51) Int. Cl. G06T 7/254

(52) U.S. Cl. CPC G06T 7/254; G06T 2207/20076; G06T 2207/20224; G06T 2207/30196

(57) ABSTRACT

A human body detection device detects a human body from a captured image; determines, based on the image, whether the human body detected is a moving body; determines whether the human body detected satisfies a predetermined condition shown by a human body framed in the image; maintains a first mode until the predetermined condition is determined to be satisfied; switches from the first mode to a second mode in response to determination that the predetermined condition is satisfied; outputs information on a human body when the human body detected is determined to be a moving body in the first mode; and outputs information on the human body regardless of whether the human body detected is determined to be a moving body in the second mode.

### TECHNICAL FIELD

The present invention relates to a technique for detecting a human body from a captured image.

### BACKGROUND ART

As a technique for detecting a human body from a captured image, moving body detection and human body detection have been known. A technique related to the moving body detection is disclosed in, for example, Patent Document 1.

### CITATION LIST

### Patent Literature

Patent Document 1: Japanese Unexamined Patent Publication No. 2000-105835

### SUMMARY OF INVENTION

### Technical Problem

However, in the moving body detection, all moving bodies such as a robot arm are detected. In addition, in the moving body detection, a stationary human body cannot be detected. In the human body detection, a stationary human body can be detected, but an object similar to a human body such as a mannequin doll may be erroneously detected as a human body. Therefore, neither the moving body detection nor the human body detection can detect the human body with high accuracy.

The present invention has been made in view of the above circumstances, and an object of the present invention is to provide a technique enabling detection of a human body with high accuracy.

### Solution to Problem

In order to achieve the above object, the present invention adopts the following configurations.

A first aspect of the present invention provides a human body detection device including: a human body detection section configured to detect a human body from a captured image; a moving body determination section that determines, based on the image, whether the human body detected by the human body detection section is a moving body; a condition determination section configured to determine whether the human body detected by the human body detection section satisfies a predetermined condition shown by a human body framed in the image; a mode setting section that maintains a first mode until the condition determination section determines that the predetermined condition is satisfied, and switches from the first mode to a second mode in response to the condition determination section determining that the predetermined condition is satisfied; and an information output section that outputs information on a human body when the moving body determination section determines that the human body detected by the human body detection section is a moving body in the first mode, and outputs information on the human body regardless of whether the moving body determination section determines that the human body detected by the human body detection section is a moving body in the second mode. The information on the human body includes, for example, an identifier assigned to the human body, information indicating a position (or a region) where the human body has been detected, and the like.

In the above-described configuration, until the detected human body satisfies the predetermined condition that the human body framed in the captured image shows, when it is determined that the detected human body is a moving body, information on the human body is output (first mode). That is, the human body is detected by a combination of the moving body detection and the human body detection (a logical product (AND) of a result of the moving body detection and a result of the human body detection is considered as a detection result of the human body). Thus, the human body as a moving body can be detected with high accuracy. However, when the human body is stationary, the human body cannot be detected. Therefore, in the above-described configuration, after the detected human body satisfies the predetermined condition, information on the human body is output regardless of whether or not the detected human body has been determined to be a moving body (second mode). That is, the human body is detected by the human body detection. Accordingly, even when the human body is stationary, the human body can be detected with high accuracy (after the human body is framed in the captured image, the human body can be detected with high accuracy by the human body detection).

The mode setting section may also be configured to set a mode for each human body detected by the human body detection section. Thus, a plurality of human bodies can be detected with high accuracy.

The moving body determination section may also be configured not to determine whether the human body detected by the human body detection section is a moving body in the second mode, and determine whether the human body detected by the human body detection section is a moving body in the first mode. This can reduce the processing load of the moving body detection (determination as to whether or not the human body detected by the human body detection section is a moving body).

When a human body is framed out from a captured image, another object similar to the human body may be erroneously detected as the human body in the human body detection. Therefore, the mode setting section may also be configured to reset the mode to the first mode when the human body detection section no longer detects a human body. In this way, since the human body is detected by a combination of the moving body detection and the human body detection, it is possible to prevent another object similar to the human body that is no longer detected from being erroneously detected as the human body. The case where the human body is no longer detected by the human body detection section is, for example, a case where the human body is not detected even once by the human body detection section, or a case where a state continues longer than a predetermined period of time in which the human body is not detected by the human body detection section.

When a human body is framed in a captured image, the human body often shows a relatively long motion with a relatively large motion amount. Therefore, the predetermined condition may be a condition that the human body moves for a longer period of time than a predetermined period of time with a motion amount larger than a predetermined amount. The predetermined condition may be a condition that a total period of time for which the human body moves with a motion amount larger than a predetermined amount in a predetermined duration until present is longer than a predetermined period of time. By using the latter condition as the predetermined condition, even if the human body repeats movement and standstill, switching from the first mode to the second mode can be suitably carried out.

A place (for example, a place where a person mainly performs work) where the framed-in human body mainly acts is often determined in advance. Therefore, the predetermined condition may be a condition that a human body moves from an outside of a predetermined range to an inside of the predetermined range in the image. In this way, since a combination of the moving body detection and the human body detection is applied to an object (not a human body) present within a predetermined range from the beginning, it is possible to suppress erroneous detection of the object as a human body. The predetermined range is, for example, a central portion of an image captured so as to look down a floor or the ground from directly above, and in a case where such an image is a fisheye image, the predetermined range is a circular range in which a distance from the center of the image is no greater than a predetermined distance.

A place (for example, a doorway of a room) through which the human body passes when the human body frames in is often determined in advance. Therefore, the predetermined condition may be a condition that a human body moves from an inside of a predetermined range to an outside of the predetermined range in the image. In this way, since a combination of the moving body detection and the human body detection is applied to an object (not a human body) framed in from a place other than the predetermined range, it is possible to suppress erroneous detection of the object as a human body.

The human body detection section may be configured to calculate a reliability that is a probability that a detected human body is a human body when the human body is detected from the image, and the predetermined condition may be a condition that an accumulated value of the reliability when the moving body determination section determines that the human body detected by the human body detection section is a moving body is higher than a predetermined value. In this way, since the combination of the moving body detection and the human body detection is applied to the object having a low accumulated value, it is possible to suppress erroneous detection of another object similar to the human body as the human body. In addition, even when the human body repeats movement and standstill, switching from the first mode to the second mode can be suitably carried out.

A second aspect of the present invention provides a human body detection method including: a human body detection step of detecting a human body from a captured image; a moving body determination step of determining, based on the image, whether the human body detected in the human body detection step is a moving body; a condition determination step of determining whether the human body detected in the human body detection step satisfies a predetermined condition shown by a human body framed in the image; a mode setting step of maintaining a first mode until the predetermined condition is determined to be satisfied in the condition determination step, and switching from the first mode to a second mode in response to the predetermined condition being determined to be satisfied in the condition determination step; and an information output step of outputting information on a human body when the human body detected in the human body detection step is determined to be a moving body in the moving body determination step in the first mode, and outputs information on the human body regardless of whether the human body detected in the human body detection step is determined to be a moving body in the moving body determination step in the second mode.

Note that the present invention can be regarded as a human body detection system having at least a part of the above-described configuration or function. In addition, the present invention can also be regarded as a method for controlling a human body detection method or a human body detection system including at least a part of the above-described processing, a program for causing a computer to execute these methods, or a computer-readable recording medium in which such a program is non-transiently recorded. Each of the above-described configurations and processes can be combined with each other to constitute the present invention as long as no technical contradiction occurs.

### Advantageous Effects of Invention

According to the present invention, a human body can be detected with high accuracy.

### BRIEF DESCRIPTION OF DRAWINGS

FIG. 1 is a block diagram illustrating a configuration example of a human body detection device to which the present invention is applied.

FIG. 2A is a schematic diagram illustrating a rough configuration example of the human body detection system according to a first embodiment of the present invention, and FIG. 2B is a block diagram illustrating a configuration example of a PC according to the embodiment.

FIG. 3 is a diagram illustrating a state in which a difference image according to the first embodiment of the present invention is being generated.

FIG. 4 is a flowchart illustrating an example of a processing flow of the PC according to the first embodiment of the present invention.

FIG. 5 is a diagram illustrating a specific example of an operation according to the first embodiment of the present invention.

FIG. 6 is a flowchart illustrating an example of a processing flow of a PC according to a second embodiment of the present invention.

FIG. 7 is a diagram illustrating a specific example of an operation according to the second embodiment of the present invention.

FIG. 8 is a block diagram illustrating a configuration example of a PC according to a third embodiment of the present invention.

FIG. 9 is a flowchart illustrating an example of a processing flow of the PC according to the third embodiment of the present invention.

FIG. 10 is a diagram illustrating a specific example of the operation according to the third embodiment of the present invention.

FIG. 11 is a block diagram illustrating a configuration example of a PC according to a fourth embodiment of the present invention.

FIG. 12 is a diagram illustrating an example of an activity range according to the fourth embodiment of the present invention.

FIG. 13 is a flowchart illustrating an example of a processing flow of the PC according to the fourth embodiment of the present invention.

FIG. 14 is a diagram illustrating an example of an entry/exit range according to a fifth embodiment of the present invention.

FIG. 15 is a flowchart illustrating an example of a processing flow of the PC according to the fifth embodiment of the present invention.

FIG. 16 is a flowchart illustrating an example of a processing flow of a PC according to a sixth embodiment of the present invention.

FIG. 17 is a diagram illustrating a specific example of the operation according to the sixth embodiment of the present invention.

### DESCRIPTION OF EMBODIMENTS

### Application Example

An application example of the present invention will be described.

In the moving body detection, all moving bodies such as a robot arm are detected. In addition, in the moving body detection, a stationary human body cannot be detected. In the human body detection, a stationary human body can be detected, but an object similar to a human body such as a mannequin doll may be erroneously detected as a human body. Therefore, neither the moving body detection nor the human body detection can detect the human body with high accuracy.

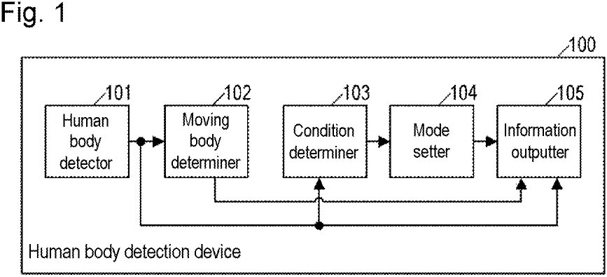

FIG. 1 is a block diagram illustrating a configuration example of a human body detection device 100 to which the present invention is applied. The human body detection device 100 includes a human body detector 101, a moving body determiner 102, a condition determiner 103, a mode setter 104, and an information outputter 105. The human body detector 101 detects a human body from a captured image. The moving body determiner 102 determines, based on the captured image, whether the human body detected by the human body detector 101 is a moving body. The condition determiner 103 determines whether the human body detected by the human body detector 101 satisfies a predetermined condition shown by a human body framed in the image. The mode setter 104 maintains a first mode until the condition determiner 103 determines that the predetermined condition is satisfied, and switches from the first mode to a second mode in response to the condition determiner 103 determining that the predetermined condition is satisfied. In the first mode, when the moving body determiner 102 determines that the human body detected by the human body detector 101 is a moving body, the information outputter 105 outputs information on the human body. Furthermore, in the second mode, the information outputter 105 outputs information on the human body regardless of whether the moving body determiner 102 has determined that the human body detected by the human body detector 101 is a moving body. The human body detector 101 is the example of a human body detection section of the present invention, the moving body determiner 102 is an example of the moving body determination section of the present invention, and the condition determiner 103 is an example of the condition determination section of the present invention. The mode setter 104 is an example of the mode setting section of the present invention, and the information outputter 105 is an example of the information output section of the present invention. The information on the human body includes, for example, an identifier assigned to the human body, information indicating a position (or a region) where the human body has been detected, and the like.

In the above-described configuration, until the detected human body satisfies the predetermined condition that the human body framed in the captured image shows, when it is determined that the detected human body is a moving body, information on the human body is output (first mode). That is, the human body is detected by a combination of the moving body detection and the human body detection (a logical product (AND) of a result of the moving body detection and a result of the human body detection is considered as a detection result of the human body). Thus, the human body as a moving body can be detected with high accuracy. However, when the human body is stationary, the human body cannot be detected. Therefore, in the above-described configuration, after the detected human body satisfies the predetermined condition, information on the human body is output regardless of whether or not the detected human body has been determined to be a moving body (second mode). That is, the human body is detected by the human body detection. Accordingly, even when the human body is stationary, the human body can be detected with high accuracy (after the human body is framed in the captured image, the human body can be detected with high accuracy by the human body detection).

### First Embodiment

The first embodiment of the present invention will be described.

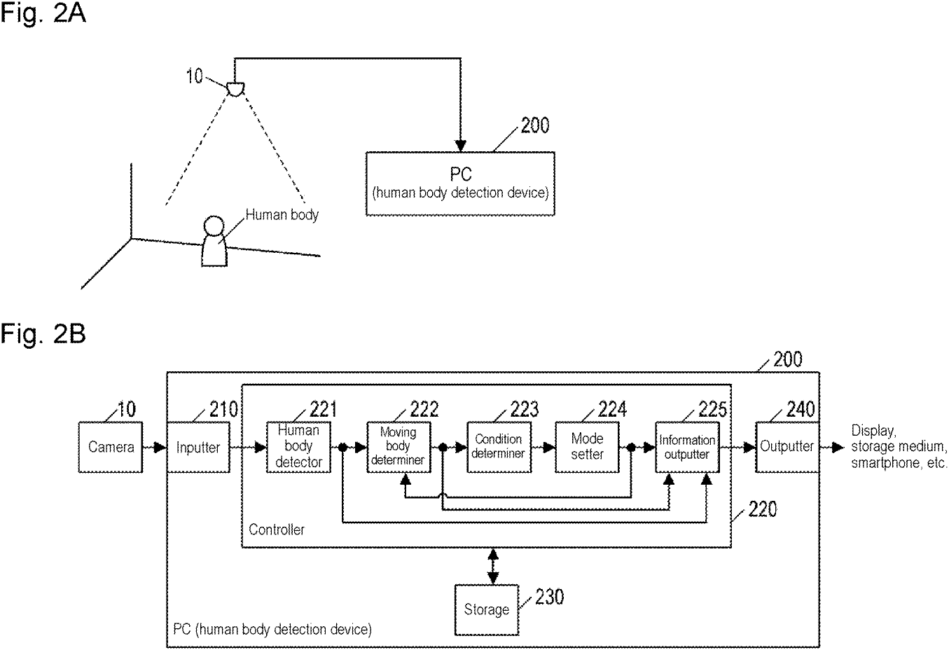

FIG. 2A is a schematic diagram illustrating a rough configuration example of the human body detection system according to the first embodiment. The human body detection system according to the first embodiment includes a camera 10 and a PC(personal computer; the human body detection device) 200. The camera 10 and the PC 200 are connected to each other in a wired or wireless manner. The camera 10 captures an image and outputs the image to the PC 200. An imaging direction of the camera 10 is not particularly limited, but in the first embodiment, it is assumed that an image is captured so as to look down the floor or the ground from directly above. The type of the captured image is also not particularly limited, but in the first embodiment, it is assumed that a fisheye image is captured. The PC 200 detects a human body from an image captured by the camera 10. The PC 200 displays information on the detected human body (an identifier assigned to the human body, information indicating a position (or region) where the human body is detected, and the like) on a display, records the information in a storage medium, or outputs the information to another terminal (such as a smartphone of an administrator in a remote place).

Note that, in the first embodiment, the PC 10 is a separate device from the camera 10, but the PC 200 may be built in the camera 10. The display and the storage medium described above may or may not be a part of the PC 200. The installation site of the PC 200 is not particularly limited. For example, the PC 200 may or may not be installed in the same room as the camera 10. The PC 200 may or may not be a computer on a cloud. The PC 200 may be a terminal such as a smartphone carried by an administrator.

FIG. 2B is a block diagram illustrating a configuration example of the PC 200. The PC 200 includes an inputter 210, a controller 220, a storage 230, and an outputter 240.

In the first embodiment, it is assumed that the camera 10 captures a video. The inputter 210 sequentially carries out processing of acquiring a captured image (frame of the video) from the camera 10 and outputting the image to the controller 220. Note that the camera 10 may also be configured to sequentially capture still images. In this case, the inputter 210 sequentially carries out processing of acquiring the captured still images from the camera 10 and outputting the acquired still images to the controller 220.

The controller 220 includes a central processing unit (CPU), a random access memory (RAM), a read only memory (ROM), and the like, and carries out control of each constituent element, various information processing, and the like. In the first embodiment, the controller 220 detects a human body from a captured image, and outputs information (an identifier assigned to the human body, information indicating a position (or region) where the human body is detected, and the like) on the detected human body to the outputter 240.

The storage 230 stores programs executed by the controller 220, various data used by the controller 220, and the like. For example, the storage 230 is an auxiliary storage device such as a hard disk drive or a solid state drive.

The outputter 240 displays information (information on the detected human body) output by the controller 220 on a display, records the information in a storage medium, or outputs the information to another terminal (such as a smartphone of an administrator in a remote place).

The controller 220 will be described in more detail. The controller 220 includes a human body detector 221, a moving body determiner 222, a condition determiner 223, a mode setter 224, and an information outputter 225.

The human body detector 221 acquires an image captured by the camera 10 from the inputter 210, and detects a human body from the acquired image. Then, the human body detector 221 outputs the detected human body information to the moving body determiner 222 and the information outputter 225. The human body detector 221 is an example of the human body detection section of the present invention.

Note that any algorithm may be used for the human body detection by the human body detector 221. For example, a detector (identifier) combining an image feature such as HoG or Haar-like and boosting may be used to detect the human body. The human body may be detected by using a learned model generated by existing machine learning, and specifically, the human body may be detected using a learned model generated by deep learning (for example, R-CNN, Fast R-CNN, YOLO, SSD, and the like).

The moving body determiner 222 acquires the image captured by the camera 10 from the inputter 210, and acquires a detection result (human body detection result) by the human body detector 221 from the human body detector 221. The moving body determiner 222 determines, based on the acquired image, whether the human body detected by the human body detector 221 is a moving body. Then, the moving body determiner 222 outputs a result of the moving body detection (determination as to whether or not the human body detected by the human body detector 221 is a moving body) to the condition determiner 223 and the information outputter 225. The moving body determiner 222 is an example of the moving body determination section of the present invention.

Note that any algorithm may be used for the moving body determination by the moving body determiner 222. For example, the moving body determiner 222 may detect a moving body by a background subtraction method or may detect a moving body by a frame subtraction method. The background subtraction method is, for example, a method of detecting, as a motion pixel, a pixel having a difference (absolute value) in pixel value from a predetermined background image of no less than a predetermined threshold in a captured image. The frame subtraction method is, for example, a method of detecting, as a motion pixel, a pixel having a difference in pixel value from a captured past image (past frame) in a captured current image (current frame) of no less than a predetermined threshold. In the frame subtraction method, for example, the past frame is a frame preceding the current frame by a predetermined number, and the predetermined number is at least one. The predetermined number (the number of frames from the current frame to the past frame) may be determined according to the frame rate of the processing (process for detecting the human body and outputting information on the detected human body) of the controller 220, the frame rate of imaging by the camera 10, and the like.

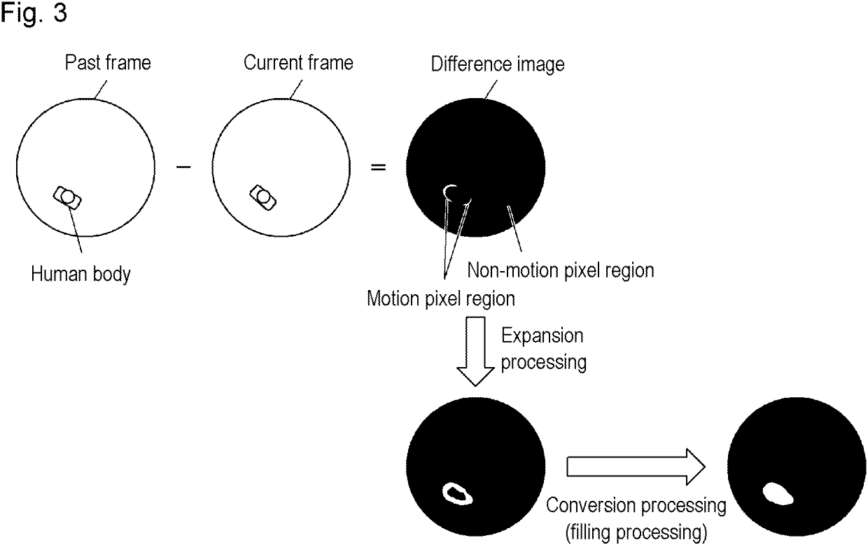

In the first embodiment, it is assumed that the moving body determiner 222 generates a difference image in the moving body detection. The difference image represents a difference between a captured image and a predetermined background image in the case of the background subtraction method, and represents a difference between a captured current image and a captured past image in the case of the frame subtraction method. FIG. 3 illustrates a state in which a difference image is generated by the frame subtraction method. In the difference image of FIG. 3, the motion pixels are white pixels, and the pixels that are not motion pixels (non-motion pixels) are black pixels. Then, the moving body determiner 222 calculates the motion amount of the human body detected by the human body detector 221 on the basis of the difference image, and determines (detects) a human body with the calculated motion amount larger than a predetermined amount as a moving body. The motion amount of the human body is, for example, a ratio of the number of motion pixels in the region of the human body to the number of pixels of the human body. As shown in FIG. 3, when calculating the motion amount, the moving body determiner 222 may carry out expansion processing of expanding a region of a moving body (region including motion pixels), conversion processing of converting pixels (non-motion pixels) in a region surrounded by motion pixels into motion pixels, and the like. In FIG. 3, the conversion processing can also be said to be a filling processing of filling with white a region (black) surrounded by white.

The condition determiner 223 acquires a determination result (result of the moving body detection) by the moving body determiner 222 from the moving body determiner 222. Then, the condition determiner 223 determines whether or not the human body detected by the human body detector 221 (the human body determined to be a moving body by the moving body determiner 222) satisfies the frame-in condition on the basis of the acquired determination result. The frame-in condition is a predetermined condition that is shown by a human body framed in the captured image. Then, the condition determiner 223 outputs a determination result as to whether the frame-in condition is satisfied to the mode setter 224. The condition determiner 223 is an example of the condition determination section of the present invention.

When a human body is framed in a captured image, the human body often shows a relatively long motion with a relatively large motion amount. Therefore, in the first embodiment, a condition that the human body moves for longer than a predetermined period of time with a motion amount larger than a predetermined amount is used as the frame-in condition.

The mode setter 224 sets a mode (operation mode) of the PC 200. In the first embodiment, the mode setter 224 sets a mode for the moving body determiner 222 and the information outputter 225. In addition, it is assumed that the first mode is set by default. The mode setter 224 acquires the determination result by the condition determiner 223 from the condition determiner 223, and maintains the first mode until the condition determiner 223 determines that the frame-in condition is satisfied. Then, the mode setter 224 switches from the first mode to the second mode in response to the condition determiner 223 determining that the frame-in condition is satisfied. The mode setter 224 is an example of the mode setting section of the present invention.

In the first embodiment, it is assumed that the human body detector 221 can detect a plurality of human bodies from one image, and the mode setter 224 sets the mode for each human body detected by the human body detector 221. Thus, a plurality of human bodies can be detected with high accuracy. Note that, in a case where the number of human bodies that can be detected from one image by the human body detector 221 is one, association between the human body and the mode is not necessary.

The information outputter 225 acquires a detection result (human body detection result) by the human body detector 221 from the human body detector 221, and acquires a determination result (moving body detection result) by the moving body determiner 222 from the moving body determiner 222. Then, in the first mode, when the moving body determiner 222 determines that the human body detected by the human body detector 221 is a moving body, the information outputter 225 outputs information on the human body to the outputter 240 as a final human body detection result. Furthermore, in the second mode, regardless of whether or not the moving body determiner 222 determines that the human body detected by the human body detector 221 is a moving body, the information outputter 225 outputs information on the human body to the outputter 240 as a final human body detection result. Therefore, the first mode can also be referred to as a moving body effective mode, and the second mode can also be referred to as a moving body ineffective mode. The information outputter 225 is an example of the information output section of the present invention.

In the first embodiment, the moving body determiner 222 is configured not to determine whether the human body detected by the human body detector 221 is a moving body in the second mode, and to determine whether the human body detected by the human body detector 221 is a moving body in the first mode. Therefore, the first mode can also be referred to as a moving body detection mode, and the second mode can also be referred to as a moving body non-detection mode. This can reduce the processing load of the moving body detection (determination as to whether or not the human body detected by the human body detector 221 is a moving body). Note that the moving body determiner 222 may carry out the moving body detection in both the first mode and the second mode. In this case, the mode setter 224 may be configured to set the mode to the information outputter 225 without setting the mode to the moving body determiner 222.

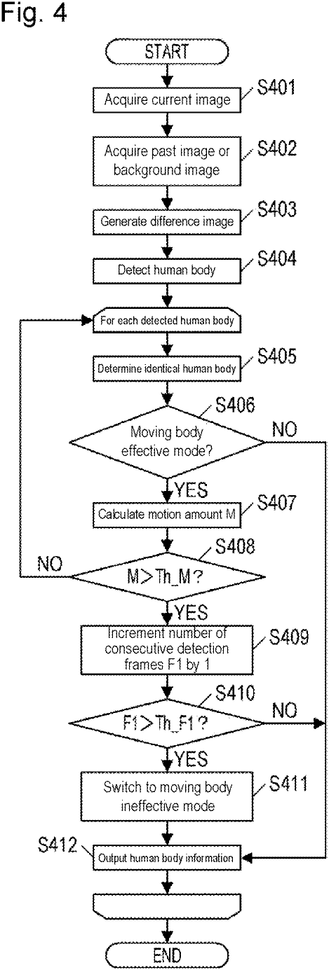

FIG. 4 is a flowchart illustrating a processing flow example of the PC 200. The PC 200 repeatedly executes the processing flow of FIG. 4. The repetition period of the processing flow of FIG. 4 is not particularly limited, but in the first embodiment, it is assumed that the processing flow of FIG. 4 is repeated at a frame rate (for example, 30 fps) of imaging by the camera 10.

First, the inputter 210 acquires a captured image (current frame) from the camera 10 (step S401). Next, the moving body determiner 222 acquires an image captured in the past (past frame) or a predetermined background image from the storage 230 (step S402). Then, the moving body determiner 222 generates a difference image from the image acquired in step S401 and the image acquired in step S402 (step S403). Next, the human body detector 221 detects a human body from the image acquired in step S401 (step S404). Then, the processing of steps S405 to S412 is carried out for each human body detected in step S404.

In step S405, the human body detector 221 determines whether or not the human body to be processed (the human body currently detected) has been detected in the past (identical human body determination). The human body detector 221 assigns a new identifier (ID) to the human body to be processed when the human body to be processed has not been detected in the past, and assigns the same identifier as the identifier assigned in the past to the human body to be processed when the human body to be processed has been detected in the past. The method of the identical human body determination is not particularly limited, but for example, in a case where the difference between the position of the human body to be processed (such as the center position of the detection rectangle) and the previously detected position of the human body is no greater than threshold, the human body to be processed can be determined to be the same as the previously detected human body. Also when the intersection over union (IoU) between the area of the human body to be processed (detection rectangle or the like) and the area of the human body previously detected is no greater than a threshold value, the human body to be processed can be determined to be the same as the human body previously detected. Whether the human body to be processed has been detected in the past can also be determined by the person re-identification.

Next, the moving body determiner 222 and the information outputter 225 determine whether the moving body effective mode (moving body detection mode; the first mode) is set for the human body to be processed (step S406). When it is determined that the moving body effective mode is set (step S406: YES), the process proceeds to step S407. When it is determined that the moving body effective mode has not been set (step S406: NO), that is, when the moving body ineffective mode (the moving body non-detection mode; the second mode) is determined to be set, the processing proceeds to step S412.

In step S407, the moving body determiner 222 calculates the motion amount M of the human body to be processed on the basis of the difference image generated in step S403. Then, the moving body determiner 222 determines whether or not the motion amount M calculated in step S407 is greater than a predetermined amount Th_M (step S408). When it is determined that the motion amount M is greater than the predetermined amount Th_M (step S408: YES), the moving body determiner 222 determines that the human body to be processed is a moving body. Then, the processing proceeds to step S409. When it is determined that the motion amount M is no greater than the predetermined amount Th_M (step S408: NO), the moving body determiner 222 determines that the human body to be processed is not a moving body. Then, in a case where an unprocessed human body (human body detected in step S404 but not having been subjected to the processing in steps S405 to S412) remains, the human body to be processed is switched to the unprocessed human body, and the processing of steps S405 to S412 is carried out. In a case where no unprocessed human body remains, the processing flow of FIG. 4 is terminated.

In step S409, the condition determiner 223 increments the number of consecutive moving frames F1 of the human body to be processed by one. The number of consecutive moving frames F1 is the number of frames continuously determined that the human body detected by the human body detector 221 is a moving body, and corresponds to a time during which the human body continues to move with a motion amount greater than a predetermined amount. The initial value of the number of consecutive moving frames F1 is zero, and when the human body detector 221 does not detect the corresponding human body or determines that the human body is not a moving body, the number of consecutive moving frames F1 is reset to zero.

Next, the condition determiner 223 determines whether the number of consecutive moving frames F1 of the human body to be processed is greater than a predetermined number Th_F1 (step S410). The predetermined number Th_F1 corresponds to “predetermined period of time” in the frame-in condition that “the human body has moved for longer than a predetermined period of time with a motion amount larger than a predetermined amount”. When it is determined that the number of consecutive moving frames F1 is greater than the predetermined number Th_F1 (step S410: YES), that is, when it is determined that the frame-in condition is satisfied, the process proceeds to step S411. When it is determined that the number of consecutive moving frames F1 is no greater than the predetermined number Th_F1 (step S410: NO), that is, when it is determined that the frame-in condition is not satisfied, the process proceeds to step S412.

In step S411, the mode setter 224 switches the mode of the human body to be processed from the moving body effective mode to the moving body ineffective mode. Then, the processing proceeds to step S412.

In step S412, the information outputter 225 outputs information on the human body to be processed. Then, in a case where an unprocessed human body (human body detected in step S404 but not having been subjected to the processing in steps S405 to S412) remains, the human body to be processed is switched to the unprocessed human body, and the processing of steps S405 to S412 is carried out. In a case where no unprocessed human body remains, the processing flow of FIG. 4 is terminated.

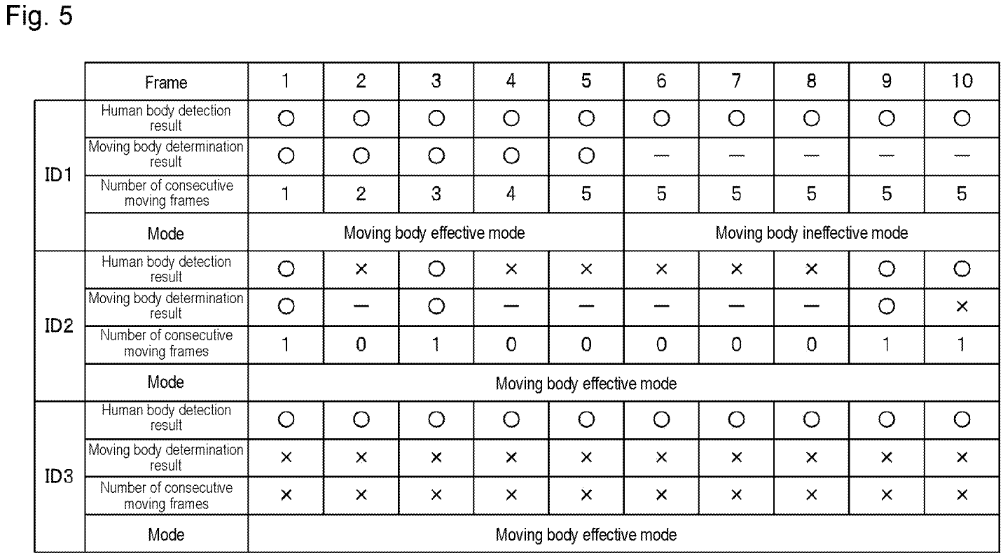

FIG. 5 illustrates a specific example of the operation according to the processing flow of FIG. 4. Specifically, FIG. 5 shows examples of a frame, a human body identifier (ID), a detection result by the human body detector 221, a determination result by the moving body determiner 222, the number of consecutive moving frames F1, and a mode. In the detection result by the human body detector 221, “o” section that the human body is detected, and “×” section that the human body is not detected. In the determination result by the moving body determiner 222, “o” section that it is determined that the human body is determined to be a moving body, “x” section that the human body is determined not to be a moving body, and “-” section that determination has not been carried out. The predetermined number Th_F1 to be compared with the number of consecutive moving frames F1 is not particularly limited, and is assumed to be four herein. That is, when the number of consecutive moving frames F1 reaches five, switching from the moving body effective mode to the moving body ineffective mode is carried out.

ID1 is an identifier of a human body. Since the number of consecutive moving frames F1 reaches five in the frame 5, switching to the moving body ineffective mode is carried out between the frame 5 and the frame 6. As a result, even when the human body of ID1 is stationary, information on the human body can be output.

ID2 is an identifier of a robot arm erroneously detected as a human body by the human body detector 221. Since the frequency at which the human body detector 221 erroneously detects the robot arm as a human body is low and the number of consecutive moving frames F1 does not reach 5, the moving body effective mode is maintained. As a result, since the combination of the moving body detection and the human body detection continues to be applied, it is possible to suppress the output of the information of the robot arm as the information of the human body.

ID3 is an identifier of a mannequin doll erroneously detected as a human body by the human body detector 221. Even if the human body detector 221 erroneously detects the mannequin doll as a human body, the frequency of determining that the mannequin doll is a moving body is low, and the number of consecutive moving frames F1 does not reach 5, so that the moving body effective mode is maintained. As a result, since the combination of the moving body detection and the human body detection continues to be applied, it is possible to suppress the output of the information of the mannequin doll as the information of the human body.

As described above, in the first embodiment, until the detected human body satisfies the frame-in condition, when it is determined that the detected human body is a moving body, information on the human body is output (moving body effective mode). That is, the human body is detected by a combination of the moving body detection and the human body detection (a logical product (AND) of a result of the moving body detection and a result of the human body detection is considered as a detection result of the human body). Thus, the human body as a moving body can be detected with high accuracy. However, when the human body is stationary, the human body cannot be detected. Therefore, in the first embodiment, after the detected human body satisfies the frame-in condition, information on the human body is output regardless of whether or not the detected human body is determined to be a moving body (moving body ineffective mode). That is, the human body is detected by the human body detection. Accordingly, even when the human body is stationary, the human body can be detected with high accuracy (after the human body is framed in the captured image, the human body can be detected with high accuracy by the human body detection).

### Second Embodiment

The second embodiment of the present invention will be described. The configuration of the human body detection system according to the second embodiment is similar to that of the first embodiment, and the configuration of the PC 200 (human body detection device) according to the second embodiment is similar to that of the first embodiment. In the second embodiment, the frame-in condition is different from that in the first embodiment.

As described in the first embodiment, when a human body is framed in a captured image, the human body often shows a relatively long motion with a relatively large motion amount. Therefore, in the second embodiment, a condition that the total period of time for which the human body has moved with a motion amount larger than a predetermined amount in a predetermined duration until present is longer than a predetermined period of time is used as the frame-in condition. In this way, even if the human body repeats movement and standstill, switching from the moving body effective mode to the moving body ineffective mode can be suitably carried out.

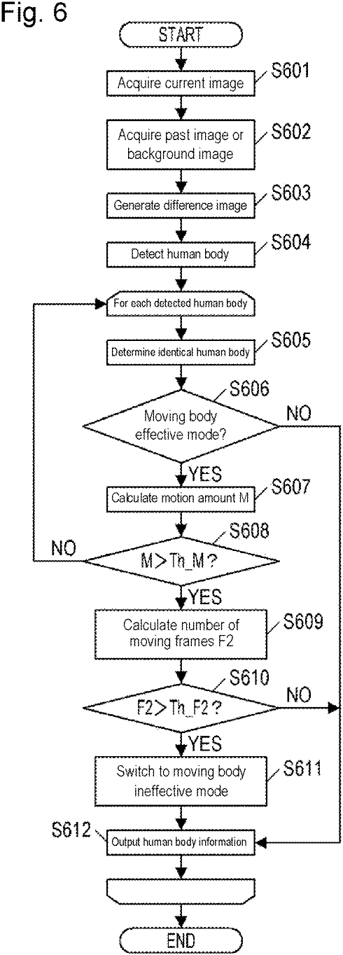

FIG. 6 is a flowchart illustrating an example of a processing flow of the PC 200 according to the second embodiment. The PC 200 repeatedly executes the processing flow of FIG. 6. The repetition period of the processing flow of FIG. 6 is not particularly limited, but in the second embodiment, it is assumed that the processing flow of FIG. 6 is repeated at a frame rate (for example, 30 fps) of imaging by the camera 10.

The processing of steps S601 to S608 is the same as the processing of steps S401 to S408 of the first embodiment. When it is determined in step S608 that the motion amount M is greater than the predetermined amount Th_M (step S608: YES), the moving body determiner 222 determines that the human body to be processed is a moving body. Then, the processing proceeds to step S609.

In step S609, the condition determiner 223 calculates the number of frames (number of moving frames F2) in which the human body to be processed is determined to be a moving body among the predetermined number of frames until present. The predetermined number of frames corresponds to a “predetermined period of time” in the frame-in condition that “total period of time for which the human body has moved with a motion amount larger than a predetermined amount in a predetermined duration until present is longer than a predetermined period of time”. The number of moving frames F2 corresponds to “total period of time for which the human body has moved with a motion amount larger than a predetermined amount” in the frame-in condition.

Next, the condition determiner 223 determines whether the number of moving frames F2 of the human body to be processed is larger than a predetermined number Th_F2 (step S610). The predetermined number Th_F2 corresponds to a “predetermined period of time” in the frame-in condition that “total period of time for which the human body has moved with a motion amount larger than a predetermined amount in a predetermined duration until present is longer than a predetermined period of time”. When it is determined that the number of moving frames F2 is larger than the predetermined number Th_F2 (step S610: YES), that is, when it is determined that the frame-in condition is satisfied, the process proceeds to step S611. When it is determined that the number of moving frames F2 is no greater than the predetermined number Th_F2 (step S610: NO), that is, when it is determined that the frame-in condition is not satisfied, the process proceeds to step S612.

The processing of steps S611 and S612 is the same as the processing of steps S411 and S412 of the first embodiment.

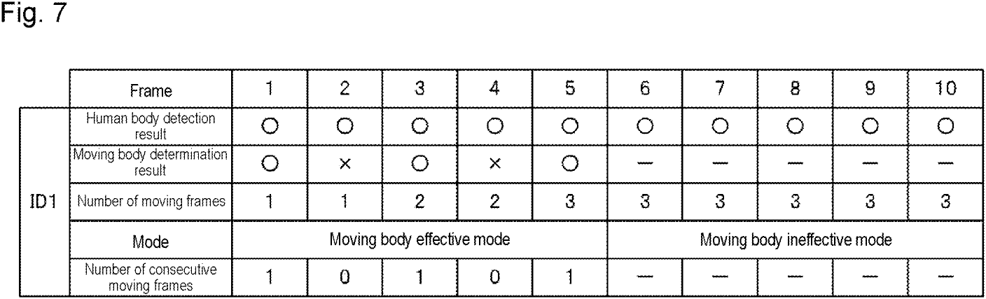

FIG. 7 illustrates a specific example of the operation according to the processing flow of FIG. 6. Specifically, FIG. 7 shows examples of a frame, a human body identifier (ID), a detection result by the human body detector 221, a determination result by the moving body determiner 222, the number of moving frames F2, and a mode. FIG. 7 also shows the number of consecutive moving frames F1 of the first embodiment. The number of frames referred to for calculating the number of moving frames F2 (predetermined number of frames until present) is not particularly limited, but is assumed to be five herein. The predetermined number Th_F2 to be compared with the number of moving frames F2 is not particularly limited, but is assumed to be two herein. That is, when the number of moving frames F2 (number of frames in which the human body detected by the human body detector 221 is determined to be a moving body among the five frames until present) reaches three, switching from the moving body effective mode to the moving body ineffective mode is carried out. The other aspects are assumed to be the same as those in the first embodiment.

ID1 is an identifier of a human body. Since the number of moving frames F2 reaches three in the frame 5, switching to the moving body ineffective mode is carried out between the frame 5 and the frame 6. As a result, even when the human body of ID1 is stationary, information on the human body can be output.

In the first embodiment, switching to the moving body ineffective mode is not carried out unless the human body detected by the human body detector 221 is continuously determined to be a moving body and the number of consecutive moving frames F1 does not reach five. Therefore, switching to the moving body ineffective mode is not carried out between the frame 5 and the frame 6. On the other hand, in the second embodiment, even when the human body detected by the human body detector 221 is intermittently determined to be a moving body, switching to the moving body ineffective mode can be suitably carried out.

As described above, also in the second embodiment, since the combination of the moving body detection and the human body detection is switched to the human body detection in response to the satisfaction of the frame-in condition, the human body can be detected with high accuracy. Furthermore, since the condition that the total period of time for which the human body has moved with a motion amount larger than a predetermined amount in a predetermined duration until present is longer than a predetermined period of time is set as the frame-in condition, the switching can be suitably carried out even if the human body repeats movement and standstill.

### Third Embodiment

A third embodiment of the present invention will be described. The configuration of the human body detection system according to the third embodiment is similar to that of the first embodiment. In the first embodiment and the second embodiment, the moving body ineffective mode is maintained after switching to the moving body ineffective mode, but in the third embodiment, the mode may be reset to the moving body effective mode.

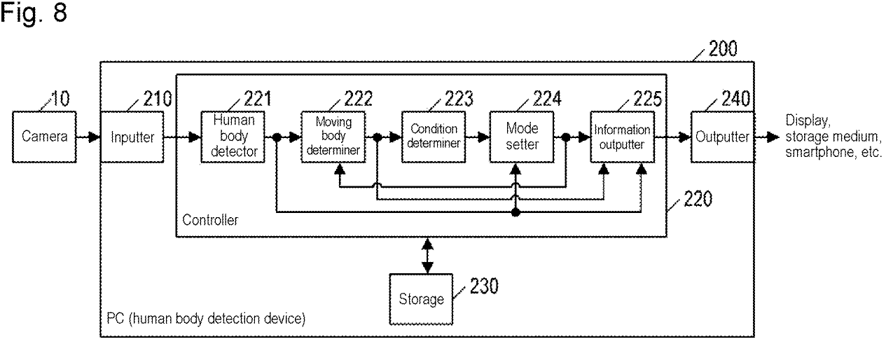

FIG. 8 is a block diagram illustrating a configuration example of the PC 200 (human body detection device) according to the third embodiment. The PC 200 according to the third embodiment has the same constituent elements as those of the first embodiment. In the third embodiment, the mode setter 224 acquires a detection result (human body detection result) by the human body detector 221 from the human body detector 221, and resets the mode to the moving body effective mode on the basis of the acquired detection result. Other processes are assumed to be the same as those of the first embodiment.

When a human body is framed out from a captured image, another object similar to the human body may be erroneously detected as the human body in the human body detection. Therefore, the mode setter 224 according to the third embodiment resets the mode to the moving body effective mode when the human body is no longer detected by the human body detector 221. In this way, since the human body is detected by a combination of the moving body detection and the human body detection, it is possible to prevent another object similar to the human body that is no longer detected from being erroneously detected as the human body. The case where the human body is no longer detected by the human body detector 221 may be a case where the human body is not detected even once by the human body detector 221, but in the third embodiment, such a case is assumed to be a case where the human body is not detected by the human body detector 221 is continued for longer than a predetermined period of time.

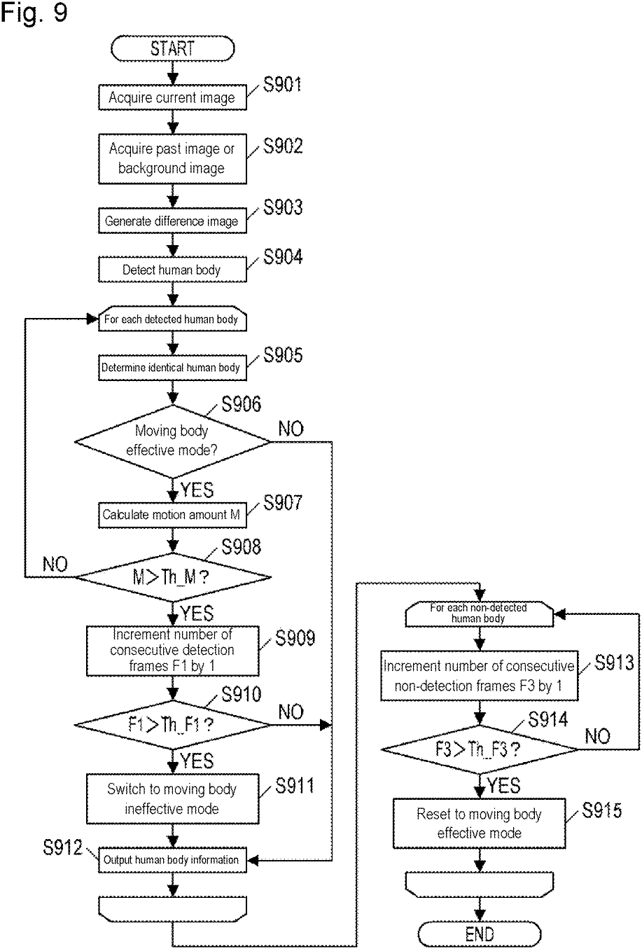

FIG. 9 is a flowchart illustrating a processing flow example of the PC 200 according to the third embodiment. The PC 200 repeatedly executes the processing flow of FIG. 9. The repetition period of the processing flow of FIG. 9 is not particularly limited, but in the third embodiment, it is assumed that the processing flow of FIG. 9 is repeated at a frame rate (for example, 30 fps) of imaging by the camera 10.

The processing of steps S901 to S912 is the same as the processing of steps S401 to S412 of the first embodiment. After the processing of steps S905 to S912 is carried out for each human body detected in step S904, the processing of step S913 to 915 is carried out for each human body not detected in step S904. Here, the human body not detected in step S904 is a human body that has been detected in the past and has been assigned an identifier, but is not currently detected.

In step S913, the mode setter 224 increments the number of consecutive non-detection frames F3 of the human body to be processed by one. The number of consecutive non-detection frames F3 is the number of consecutive frames in which the human body is not detected by the human body detector 221, and corresponds to the duration of the state in which the human body is not detected by the human body detector 221. The initial value of the number of consecutive non-detection frames F3 is zero, and when the corresponding human body is detected by the human body detector 221, the number of consecutive non-detection frames F3 is reset to zero.

Next, the mode setter 224 determines whether the number of consecutive non-detection frames F3 of the human body to be processed is larger than a predetermined number Th_F3 (step S914). The predetermined number Th_F3 corresponds to a predetermined period of time. A case where it is determined that the number of consecutive non-detection frames F3 is larger than the predetermined number Th_F3 (step S914: YES) corresponds to a case where a state in which the human body to be processed is not detected by the human body detector 221 continues longer than a predetermined period of time. In this case, the processing proceeds to step S915. A case where it is determined that the number of consecutive non-detection frames F3 is no greater than the predetermined number Th_F3 (step S914: NO) corresponds to a case where the state in which the human body is not detected by the human body detector 221 is not continued for longer than the predetermined period of time. In this case, if an unprocessed human body (human body not detected in step S904 but not having been subjected to the processing in steps S913 to S915) remains, the human body to be processed is switched to the unprocessed human body, and the processing of steps S913 to S915 is carried out. In a case where no unprocessed human body remains, the processing flow of FIG. 9 is terminated.

In step S915, the mode setter 224 resets the mode of the human body to be processed to the moving body effective mode. Then, if an unprocessed human body remains, the human body to be processed is switched to the unprocessed human body, and the processing of steps S913 to S915 is carried out. In a case where no unprocessed human body remains, the processing flow of FIG. 9 is terminated.

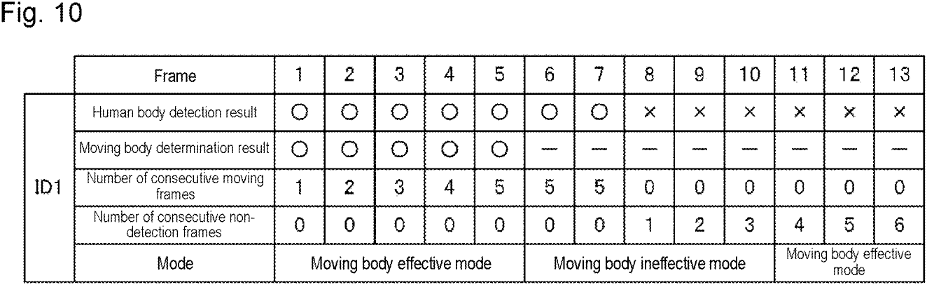

FIG. 10 illustrates a specific example of the operation according to the processing flow of FIG. 9. Specifically, FIG. 10 shows examples of a frame, a human body identifier (ID), a detection result by the human body detector 221, a determination result by the moving body determiner 222, the number of consecutive moving frames F1, the number of consecutive non-detection frames F3, and a mode. The predetermined number Th_F3 to be compared with the number of consecutive non-detection frames F3 is not particularly limited, but is assumed to be two herein. That is, when the number of consecutive non-detection frames F3 reaches three, the mode is reset to the moving body effective mode. The other aspects are assumed to be the same as those in the first embodiment.

ID1 is an identifier of a human body. Since the number of consecutive moving frames F1 reaches five in the frame 5, switching to the moving body ineffective mode is carried out between the frame 5 and the frame 6. As a result, even when the human body of ID1 is stationary, information on the human body can be output. Then, since the number of consecutive non-detection frames F3 reaches three in the frame 10, switching to the moving body ineffective mode is carried out between the frame 10 and the frame 11. As a result, it is possible to suppress output of information of another object similar to the human body of ID1.

As described above, according to the third embodiment, when the human body is no longer detected by the human body detector 221, the mode is reset to the moving body effective mode. As a result, the human body is detected by a combination of the moving body detection and the human body detection, and thus, it is possible to prevent another object similar to the human body that is no longer detected from being erroneously detected as the human body.

### Fourth Embodiment

A fourth embodiment of the present invention will be described. The configuration of the human body detection system according to the fourth embodiment is similar to that of the first embodiment. In the fourth embodiment, the frame-in condition is different from that of the first to third embodiments.

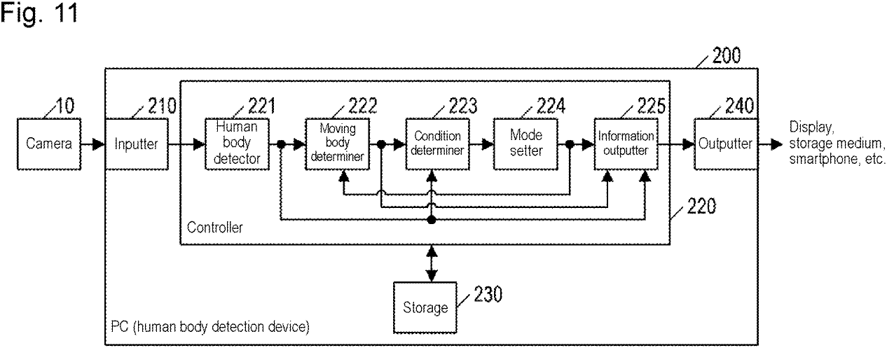

FIG. 11 is a block diagram illustrating a configuration example of the PC 200 (human body detection device) according to the fourth embodiment. The PC 200 according to the fourth embodiment has the same constituent elements as those of the first embodiment. In the fourth embodiment, the condition determiner 223 acquires a detection result (human body detection result) by the human body detector 221 from the human body detector 221, and acquires a determination result (moving body detection result) by the moving body determiner 222 from the moving body determiner 222. Then, the condition determiner 223 determines whether or not the human body detected by the human body detector 221 (the human body determined to be a moving body by the moving body determiner 222) satisfies the frame-in condition on the basis of the detection result by the human body detector 221. Other processes are assumed to be the same as those of the first embodiment.

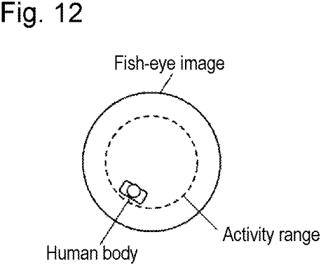

A place (for example, a place where a person mainly performs work) where the framed-in human body mainly acts is often determined in advance. Therefore, in the fourth embodiment, a condition that the human body has moved from the outside of the predetermined range to the inside of the predetermined range in the captured image is used as the frame-in condition. In this way, since a combination of the moving body detection and the human body detection is applied to an object (not a human body) present within a predetermined range from the beginning, it is possible to suppress erroneous detection of the object as a human body. Hereinafter, this predetermined range is referred to as an activity range. The activity range is, for example, a central portion of an image captured so as to look down a floor or the ground from directly above. In the fourth embodiment, similarly to the first embodiment, it is assumed that a fisheye image is captured so as to look down the floor or the ground from directly above. Then, as illustrated in FIG. 12, it is assumed that the activity range is a circular range of which the distance from the center of the fisheye image is no greater than a predetermined distance.

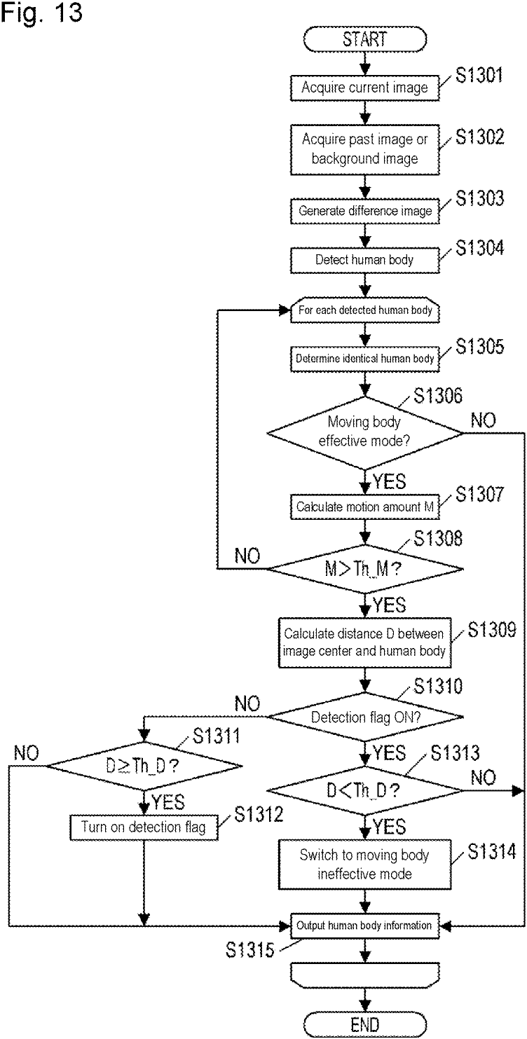

FIG. 13 is a flowchart illustrating a processing flow example of the PC 200 according to the fourth embodiment. The PC 200 repeatedly executes the processing flow of FIG. 13. The repetition period of the processing flow of FIG. 13 is not particularly limited, but in the fourth embodiment, it is assumed that the processing flow of FIG. 13 is repeated at a frame rate (for example, 30 fps) of imaging by the camera 10.

The processing of steps S1301 to S1308 is the same as the processing of steps S401 to S408 of the first embodiment. When it is determined in step S1308 that the motion amount M is greater than the predetermined amount Th_M (step S1308: YES), the moving body determiner 222 determines that the human body to be processed is a moving body. Then, the processing proceeds to step S1309.

In step S1309, the condition determiner 223 calculates a distance D from the center of the image acquired in step S1301 to the position of the human body to be processed (such as the center position of the detection rectangle).

Next, the condition determiner 223 determines whether the detection flag is ON (step S1310). When it is determined that the detection flag is ON (step S1310: YES), the process proceeds to step S1313. When it is determined that the detection flag is not ON (step S1310: NO), that is, when it is determined that the detection flag is OFF, the process proceeds to step S1311. In the fourth embodiment, the detection flag indicates whether or not the human body to be processed is detected outside the activity range, and becomes ON in response to detection of the human body to be processed outside the activity range. That is, the detection flag indicates whether or not the precondition of the frame-in condition that the human body has moved from the outside of the activity range to the inside of the activity range is satisfied, and becomes ON in response to satisfaction of the precondition. The initial state of the detection flag is OFF.

In step S1311, the condition determiner 223 determines whether or not the distance D calculated in step S1309 is no less than a predetermined distance Th_D. The predetermined distance Th_D is a radius of the activity range. When the distance D is no less than the predetermined distance Th_D, the human body to be processed is located outside the activity range. When the distance D is less than the predetermined distance Th_D, the human body to be processed is located inside the activity range. Therefore, the determination in step S1311 can also be said to be a determination as to whether or not the above-described precondition is satisfied. In a case where it is determined that the distance D is no less than the predetermined distance Th_D (step S1311: YES), that is, in a case where it is determined that the precondition is satisfied, the processing proceeds to step S1312. When it is determined that the distance D is less than the predetermined distance Th_D (step S1311: NO), that is, when it is determined that the precondition is not satisfied, the process proceeds to step S1315. In the fourth embodiment, the position where the distance D is the predetermined distance Th_D is defined as the outside of the activity range, but the position may be defined as the inside of the activity range.

In step S1312, the condition determiner 223 turns on the detection flag. Then, the processing proceeds to step S1315.

In step S1313, the condition determiner 223 determines whether or not the distance D calculated in step S1309 is less than the predetermined distance Th_D. Here, the above-described precondition is already satisfied. Therefore, the determination in step S1313 can also be said to be a determination as to whether the frame-in condition that the human body has moved from the outside of the activity range to the inside of the activity range is satisfied. When it is determined that the distance D is less than the predetermined distance Th_D (step S1313: YES), that is, when it is determined that the frame-in condition is satisfied, the process proceeds to step S1314. In a case where it is determined that the distance D is no less than the predetermined distance Th_D (step S1313: NO), that is, in a case where it is determined that the frame-in condition is not satisfied, the processing proceeds to step S1315.

The processing of steps S1314 and S1315 is the same as the processing of steps S411 and S412 of the first embodiment.

As described above, also in the fourth embodiment, since the combination of the moving body detection and the human body detection is switched to the human body detection in response to the satisfaction of the frame-in condition, the human body can be detected with high accuracy. Furthermore, by setting the condition that the human body has moved from the outside of the activity range to the inside of the activity range as the frame-in condition, it is possible to suppress erroneous detection of an object (not the human body) existing in the activity range as the human body from the beginning.

### Fifth Embodiment

A fifth embodiment of the present invention will be described. The configuration of the human body detection system according to the fifth embodiment is similar to that of the first embodiment, and the configuration of the PC 200 (human body detection device) according to the fifth embodiment is similar to that of the fourth embodiment. In the fifth embodiment, the frame-in condition is different from that of the first to fourth embodiments.

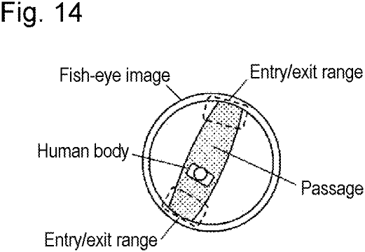

A place (for example, a doorway of a room) through which the human body passes when the human body frames in is often determined in advance. Therefore, in the fifth embodiment, a condition that the human body has moved from the inside of the predetermined range to the outside of the predetermined range in the captured image is used as the frame-in condition. In this way, since a combination of the moving body detection and the human body detection is applied to an object (not a human body) framed in from a place other than the predetermined range, it is possible to suppress erroneous detection of the object as a human body. Hereinafter, this predetermined range is referred to as an entry/exit range. For example, as illustrated in FIG. 14, the entry/exit range is ends of a passage in the captured image in the direction in which the passage extends.

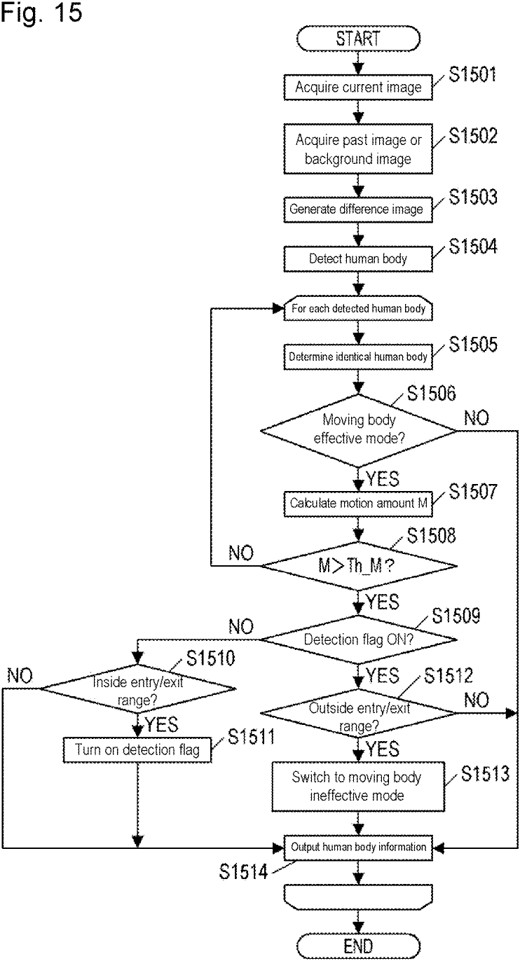

FIG. 15 is a flowchart showing a processing flow example of the PC 200 according to the fifth embodiment. The PC 200 repeatedly executes the processing flow of FIG. 15. The repetition cycle of the processing flow of FIG. 15 is not particularly limited, but in the fifth embodiment, it is assumed that the processing flow of FIG. 15 is repeated at a frame rate (for example, 30 fps) of imaging by the camera 10.

The processing of steps S1501 to S1508 is the same as the processing of steps S401 to S408 of the first embodiment. When it is determined in step S1508 that the motion amount M is greater than the predetermined amount Th_M (step S1508: YES), the moving body determiner 222 determines that the human body to be processed is a moving body. Then, the processing proceeds to step S1509.

In step S1509, the condition determiner 223 determines whether the detection flag is ON. When it is determined that the detection flag is ON (step S1509: YES), the process proceeds to step S1512. When it is determined that the detection flag is not ON (step S1509: NO), that is, when it is determined that the detection flag is OFF, the process proceeds to step S1510. In the fifth embodiment, the detection flag indicates whether or not the human body to be processed is detected inside the entry/exit range, and becomes ON in response to detection of the human body to be processed inside the entry/exit range. That is, the detection flag indicates whether or not the precondition of the frame-in condition that the human body has moved from the inside of the entry/exit range to the outside of the entry/exit range is satisfied, and becomes ON in response to satisfaction of the precondition. The initial state of the detection flag is OFF.

In step S1510, the condition determiner 223 determines whether or not the position of the human body to be processed (such as the center position of the detection rectangle) is inside the entry/exit range, that is, whether or not the above-described precondition is satisfied. In a case where it is determined that the position of the human body to be processed is inside the entry/exit range (step S1510: YES), that is, in a case where it is determined that the precondition is satisfied, the processing proceeds to step S1511. In a case where it is determined that the position of the human body to be processed is not inside (outside) the entry/exit range (step S1510: NO), that is, in a case where it is determined that the precondition is not satisfied, the processing proceeds to step S1514.

In step S1511, the condition determiner 223 turns on the detection flag. Then, the processing proceeds to step S1514.

In step S1512, the condition determiner 223 determines whether the position of the human body to be processed is outside the entry/exit range. Here, the above-described precondition is already satisfied. Therefore, the determination in step S1512 can also be said to be a determination as to whether or not the frame-in condition that the human body has moved from the inside of the entry/exit range to the outside of the entry/exit range is satisfied. In a case where it is determined that the position of the human body to be processed is outside the entry/exit range (step S1512: YES), that is, in a case where it is determined that the frame-in condition is satisfied, the processing proceeds to step S1513. In a case where it is determined that the position of the human body to be processed is not outside (inside) the entry/exit range (step S1512: NO), that is, in a case where it is determined that the frame-in condition is not satisfied, the processing proceeds to step S1514.

The processing of steps S1513 and S1514 is the same as the processing of steps S411 and S412 of the first embodiment.

As described above, also in the fifth embodiment, since the combination of the moving body detection and the human body detection is switched to the human body detection in response to the satisfaction of the frame-in condition, the human body can be detected with high accuracy. Furthermore, by setting the condition that the human body has moved from the inside of the entry/exit range to the outside of the entry/exit range as the frame-in condition, it is possible to suppress erroneous detection of an object (not a human body) framed in from a place other than the entry/exit range as a human body.

### Sixth Embodiment

A sixth embodiment of the present invention will be described. The configuration of the human body detection system according to the sixth embodiment is similar to that of the first embodiment, and the configuration of the PC 200 (human body detection device) according to the sixth embodiment is similar to that of the fourth embodiment and the fifth embodiment. In the sixth embodiment, the frame-in condition is different from that of the first to fifth embodiments.

In the sixth embodiment, the human body detector 221 calculates a reliability that is a probability that a detected human body is a human body when the human body is detected from the captured image. A method of calculating the reliability is not particularly limited, but for example, the reliability is a similarity between the feature of the detected human body and the feature predefined as the feature of the human body. The calculated reliability is notified from the human body detector 221 to the condition determiner 223. Then, in the sixth embodiment, a condition that the accumulated value of the reliability when the moving body determiner 222 determines that the human body detected by the human body detector 221 is a moving body is higher than a predetermined value is used as the frame-in condition. In this way, since the combination of the moving body detection and the human body detection is applied to the object having a low accumulated value, it is possible to suppress erroneous detection of another object similar to the human body as the human body. In addition, even if the human body repeats movement and standstill, switching from the moving body effective mode to the moving body ineffective mode can be suitably carried out.

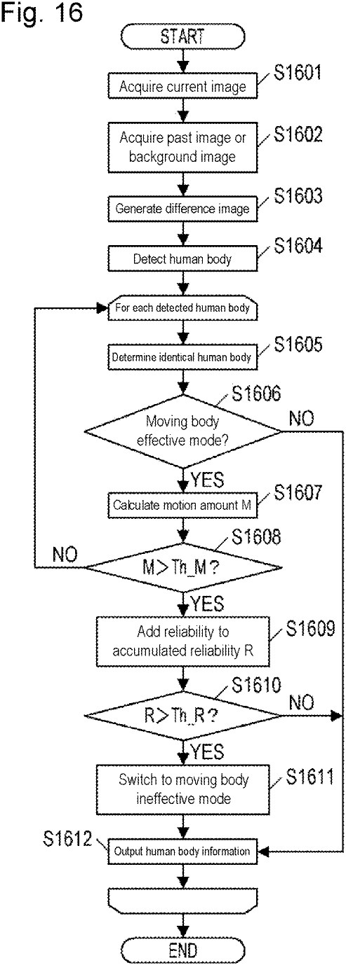

FIG. 16 is a flowchart illustrating a processing flow example of the PC 200 according to the sixth embodiment. The PC 200 repeatedly executes the processing flow of FIG. 16. The repetition cycle of the processing flow of FIG. 16 is not particularly limited, but in the sixth embodiment, it is assumed that the processing flow of FIG. 16 is repeated at a frame rate (for example, 30 fps) of imaging by the camera 10.

The processing of steps S1601 to S1608 is the same as the processing of steps S401 to S408 of the first embodiment. When it is determined in step S1608 that the motion amount M is greater than the predetermined amount Th_M (step S1608: YES), the moving body determiner 222 determines that the human body to be processed is a moving body. Then, the processing proceeds to step S1609.

In step S1609, the condition determiner 223 adds the reliability of the human body to be processed to the accumulated reliability R of the human body. The accumulated reliability R is an accumulated value of the reliability when the moving body determiner 222 determines that the human body detected by the human body detector 221 is a moving body.

Next, the condition determiner 223 determines whether the accumulated reliability R of the human body to be processed is higher than a predetermined value Th_R, that is, whether the frame-in condition is satisfied (step S1610). When it is determined that the accumulated reliability R is higher than the predetermined value Th_R (step S1610: YES), that is, when it is determined that the frame-in condition is satisfied, the process proceeds to step S1611. When it is determined that the accumulated reliability R is no higher than the predetermined value Th_R (step S1610: NO), that is, when it is determined that the frame-in condition is not satisfied, the process proceeds to step S1612.

The processing of steps S1611 and S1612 is the same as the processing of steps S411 and S412 of the first embodiment.

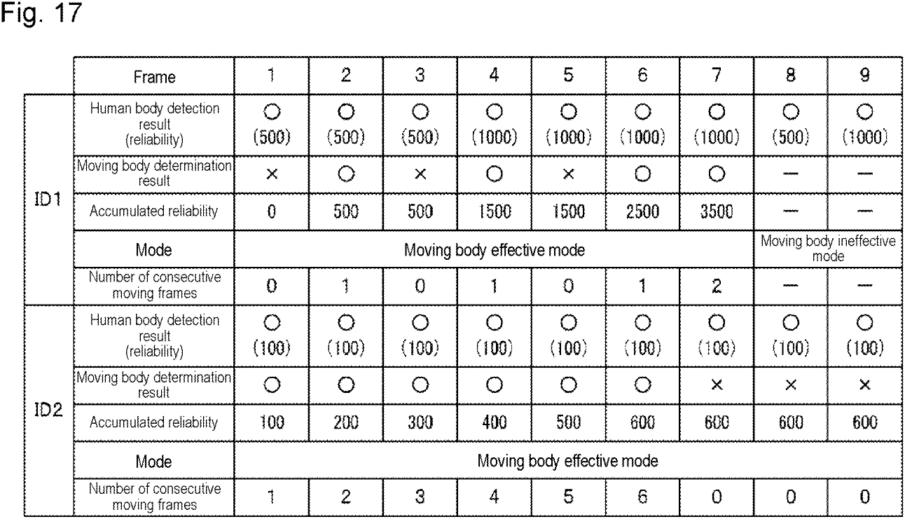

FIG. 17 illustrates a specific example of the operation according to the processing flow of FIG. 16. Specifically, FIG. 17 shows examples of a frame, a human body identifier (ID), a detection result by the human body detector 221, a determination result by the moving body determiner 222, the accumulated reliability R, and a mode. FIG. 17 also shows the number of consecutive moving frames F1 of the first embodiment. The predetermined value Th_R to be compared with the accumulated reliability R is not particularly limited, but is assumed to be 3,000 herein. That is, when the accumulated reliability exceeds 3,000, switching from the moving body effective mode to the moving body ineffective mode is carried out. The other aspects are assumed to be the same as those in the first embodiment.

ID1 is an identifier of a human body. Since the accumulated reliability R exceeds 3,000 in the frame 7, switching to the moving body ineffective mode is carried out between the frame 7 and the frame 8. As a result, even when the human body of ID1 is stationary, information on the human body can be output. In the first embodiment, switching to the moving body ineffective mode is not carried out unless the human body detected by the human body detector 221 is continuously determined to be a moving body and the number of consecutive moving frames F1 does not reach five. Therefore, switching to the moving body ineffective mode is not carried out between the frame 7 and the frame 8. On the other hand, in the second embodiment, even when the human body detected by the human body detector 221 is intermittently determined to be a moving body, switching to the moving body ineffective mode can be suitably carried out.

ID2 is an identifier of a mannequin doll erroneously detected as a human body by the human body detector 221. Since the accumulated reliability R does not exceed 3,000, the moving body effective mode is maintained. Since the mannequin doll has been moved during the duration of the frames 1 to 6, the number of consecutive moving frames F1 reaches five in the frame 5. Therefore, in the first embodiment, switching to the moving body ineffective mode is carried out between the frame 5 and the frame 6, and the information of the mannequin doll is continuously output as the information of the human body. On the other hand, in the second embodiment, since the moving body effective mode is maintained, it is possible to suppress the output of the information of the mannequin doll as the information of the human body. Specifically, after the mannequin doll stands still, the information on the mannequin doll is not output as the information on the human body.

As described above, also in the sixth embodiment, since the combination of the moving body detection and the human body detection is switched to the human body detection in response to the satisfaction of the frame-in condition, the human body can be detected with high accuracy. Furthermore, in the sixth embodiment, the probability that the human body detected by the human body detector 221 is a human body is calculated. Then, a condition that the accumulated value of the reliability when the moving body determiner 222 determines that the human body detected by the human body detector 221 is a moving body is higher than a predetermined value is used as the frame-in condition. As a result, since the combination of the moving body detection and the human body detection is applied to the object having the low accumulated reliability, it is possible to suppress erroneous detection of another object similar to the human body as the human body. In addition, even if the human body repeats movement and standstill, switching from the moving body effective mode to the moving body ineffective mode can be suitably carried out.

### Others

The above embodiment merely exemplarily describes the configuration example of the present invention. The present invention is not limited to the specific aspects described above, and various modifications can be made within the scope of the technical idea. For example, in the configuration using the frame-in condition of the second embodiment, the fourth embodiment, the fifth embodiment, and the sixth embodiment, the reset of the third embodiment (reset to the moving body effective mode) may be carried out.

### Supplementary Note 1

A human body detection device (100, 200) including:
a human body detection section (101, 221) configured to detect a human body from a captured image;
a moving body determination section (102, 222) that determines, based on the image, whether the human body detected by the human body detection section is a moving body;
a condition determination section (103, 223) configured to, on the basis of the determination result by the moving body determination section, determine whether the human body detected by the human body detection section satisfies a predetermined condition shown by a human body framed in the image;
a mode setting section (104, 224) that maintains a first mode until the condition determination section determines that the predetermined condition is satisfied, and switches from the first mode to a second mode in response to the condition determination section determining that the predetermined condition is satisfied; and
an information output section (105, 225) that outputs information on a human body when the moving body determination section determines that the human body detected by the human body detection section is a moving body in the first mode, and outputs information on the human body regardless of whether the moving body determination section determines that the human body detected by the human body detection section is a moving body in the second mode.

### Supplementary Note 2

A human body detection method including:
a human body detection step (S404, S604, S904, S1304, S1504, S1604) of detecting a human body from a captured image;
a moving body determination step (S408, S608, S908, S1308, S1508, S1608) of determining, based on the image, whether the human body detected in the human body detection step is a moving body;
a condition determination step (S410, S610, S910, S1313, S1512, S1610) of, on the basis of the determination result in the moving body determination step, determining whether the human body detected in the human body detection step satisfies a predetermined condition shown by a human body framed in the image;
a mode setting step (S411, S611, S911, S1314, S1513, S1611) of maintaining a first mode until the predetermined condition is determined to be satisfied in the condition determination step, and switching from the first mode to a second mode in response to the predetermined condition being determined to be satisfied in the condition determination step; and
an information output step (S412, S612, S912, S1315, S1514, S1612) of outputting information on a human body when the human body detected in the human body detection step is determined to be a moving body in the moving body determination step in the first mode, and outputs information on the human body regardless of whether the human body detected in the human body detection step is determined to be a moving body in the moving body determination step in the second mode.

REFERENCE SIGNS LIST

| | |
|---|---|
| 100: | human body detection device |
| 101: | human body detector |
| 102: | moving body determiner |
| 103: | condition determiner |
| 104: | mode setter |
| 105: | information outputter |
| 10: | camera |
| 200: | PC (human body detection device) |
| 210: | inputter |
| 220: | controller |
| 230: | storage |
| 240: | outputter |
| 221: | human body detector |
| 222: | moving body determiner |
| 223: | condition determiner |
| 224: | mode setter |
| 225: | information outputter |

1. A human body detection device comprising:
a human body detection section configured to detect a human body from a captured image;
a moving body determination section configured to determine, based on the image, whether the human body detected by the human body detection section is a moving body;
a condition determination section configured to determine whether the human body detected by the human body detection section satisfies a predetermined condition shown by a human body framed in the image;
a mode setting section configured to maintain a first mode until the condition determination section determines that the predetermined condition is satisfied, and switch from the first mode to a second mode in response to the condition determination section determining that the predetermined condition is satisfied; and
an information output section configured to output information on a human body when the moving body determination section determines that the human body detected by the human body detection section is a moving body in the first mode, and output information on the human body regardless of whether the moving body determination section determines that the human body detected by the human body detection section is a moving body in the second mode.

2. The human body detection device according to claim 1, wherein the mode setting section sets a mode for each human body detected by the human body detection section.

3. The human body detection device according to claim 1, wherein the moving body determination section does not determine whether the human body detected by the human body detection section is a moving body in the second mode, and determines whether the human body detected by the human body detection section is a moving body in the first mode.

4. The human body detection device according to claim 1, wherein the mode setting section resets the mode to the first mode when the human body detection section no longer detects a human body.

5. The human body detection device according to claim 1, wherein the predetermined condition is a condition that the human body moves for a longer period of time than a predetermined period of time with a motion amount larger than a predetermined amount.

6. The human body detection device according to claim 1, wherein the predetermined condition is a condition that a total period of time for which the human body moves with a motion amount larger than a predetermined amount in a predetermined duration until present is longer than a predetermined period of time.

7. The human body detection device according to claim 1, wherein the predetermined condition is a condition that a human body moves from an outside of a predetermined range to an inside of the predetermined range in the image.

8. The human body detection device according to claim 1, wherein the predetermined condition is a condition that a human body moves from an inside of a predetermined range to an outside of the predetermined range in the image.

9. The human body detection device according to claim 1, wherein
the human body detection section calculates a reliability that is a probability that a detected human body is a human body when the human body is detected from the image, and
the predetermined condition is a condition that an accumulated value of the reliability of a human body when the moving body determination section determines that the human body detected by the human body detection section is a moving body is higher than a predetermined value.

10. A human body detection method comprising:
a human body detection step of detecting a human body from a captured image;
a moving body determination step of determining, based on the image, whether the human body detected in the human body detection step is a moving body;
a condition determination step of determining whether the human body detected in the human body detection step satisfies a predetermined condition shown by a human body framed in the image;
a mode setting step of maintaining a first mode until the predetermined condition is determined to be satisfied in the condition determination step, and switching from the first mode to a second mode in response to the predetermined condition being determined to be satisfied in the condition determination step; and
an information output step of outputting information on a human body when the human body detected in the human body detection step is determined to be a moving body in the moving body determination step in the first mode, and outputs information on the human body regardless of whether the human body detected in the human body detection step is determined to be a moving body in the moving body determination step in the second mode.

11. A non-transitory computer readable medium storing a program for causing a computer to execute each step of the human body detection method according to claim 10.
